(19) United States
(12) Patent Application Publication
(10) Pub. No.: US 2012/0175275 A1
(43) Pub. Date: Jul. 12, 2012

(54) VISCOUS CHEMILUMINESCENT COMPONENTS AND DISPENSING MEANS

(76) Inventors: William R. PALMER, Rescue, CA (US); Stephen L. PALMER, Cameron Park, CA (US)

(21) Appl. No.: 13/329,265

(22) Filed: Dec. 17, 2011

Related U.S. Application Data
(60) Provisional application No. 61/424,446, filed on Dec. 17, 2010.
(60) Provisional application No. 61/533,258, filed on Sep. 11, 2011.

(51) Int. Cl. B65D 25/08; C09K 11/07

(52) U.S. Cl. 206/221; 252/700; 206/219

(57) ABSTRACT

A chemiluminescent, multiple-part marking system comprising at least one first reactant and at least one second reactant, wherein the at least one first reactant is chosen from a viscous oxalate composition, and wherein the at least one second reactant is chosen from a liquid activator. A chemiluminescent, multiple-part marking system comprising at least one first reactant and at least one second reactant, wherein the at least one first reactant is chosen from a liquid oxalate composition, and wherein the at least one second reactant is chosen from a viscous activator composition.

The present application claims priority to U.S. Provisional Patent Application No. 61/424,446, filed Dec. 17, 2010, and U.S. Provisional Patent Application No. 61/533,258, filed Sep. 11, 2011, both of which are incorporated herein by reference.

The present disclosure relates to viscous chemiluminescent compositions that can be in the form of a fluid, gel or paste, as well as a dispensing device for such viscous chemiluminescent compositions. The viscous chemiluminescent compositions of the present disclosure, which can be seen by both the naked eye and visual aid devices, comprise a viscous activator component and/or a viscous oxalate component. These components are also set forth in the present disclosure.

Military and non-military organizations use a variety of visual marking and signaling means in their training, tactical, and battlefield operations. These visual marking and signaling means are commonly referred to as signage. This signage serves to provide information such as directions, identification, or warnings. Additionally, signage or other markings can be used to visually identify the location of personnel, equipment, and vehicles. In daylight environments, paint, felt-tipped markers, or other traditional means may be employed to create signage. For operations that may take place in the dark, however, these traditional marking means may be difficult or impossible to discern. Additionally, if flashlights or other light sources are employed to view these signs, the viewer may reveal the viewer's location and/or identity. Further, traditional marking means may be viewable by persons for which the message is not intended.

Attempts to overcome the problem of creating signage or markings that can be viewed in the dark have been previously attempted. Self-illuminating marks can be created by the use of chemiluminescence. Chemiluminescence is the generation of light by a chemical reaction, and the light can be emitted in the visible, ultra-violet, or infrared spectrum as the result of the reaction. An example of one such reaction involves reacting an oxalate ester and hydrogen peroxide in the presence of a fluorescer and a catalyst.

Chemical light sticks are examples of products that are known to use chemiluminescence. It is also known to cut open chemical light sticks and spill the glowing contents on objects to be marked. However, this operation is both messy and inefficient. Furthermore, it is difficult to create precise indicia with this process. Additionally, chemiluminescent light sticks can employ liquids that tend to run when applied to surfaces. Moreover, because chemiluminescent light intensity is proportional to the volume per unit area of the applied chemiluminescent material, and because traditional chemiluminescent liquids tend to “flatten out” when applied to surfaces, the resulting light output can be of low intensity and the indicia can be of poor visibility.

Another problem with traditional chemiluminescent fluids can be seen when attempting to mark on porous surfaces. In this case the chemiluminescent fluid is quickly absorbed into the substrate surface. If the porous substrate is opaque, as is the case with wood, cardboard, concrete, soil, and so forth, light from the sub-surface fluid is not visible, resulting in low intensity light output.

Yet another problem associated with using low viscosity chemiluminescent fluids to create signage can occur if the signage is exposed to rain or water. A first problem can occur when the low viscosity chemiluminescent fluid is displaced by the water, which could potentially result in “smearing” of the indicia. A second problem can occur due to the fact that low viscosity chemiluminescent fluids “flatten out,” which can result in relatively large surface area per unit volume. Because of this, a large percentage of the chemiluminescent fluid can be directly exposed to the environment. Chemiluminescent fluid in contact with water or water vapor will become damaged and exhibit diminished light output. Still further, because many chemiluminescent fluids sustain damage when exposed to actinic radiation, such as that produced by the sun, flattened out layers of chemiluminescent fluid can be readily degraded.

There is, therefore, a need for chemiluminescent components that can be used to create indicia or other markings which are highly discernable, environmentally stable, and easy to use. It is accordingly an object of the present disclosure to provide chemiluminescent components and compositions that can provide a light-emitting indicia on a wide variety of surfaces. This indicia can be in the visible light range, the ultra-violet light range, the infrared light range, and combinations thereof, and the indicia is result of a chemical reaction. One such reaction is the activation of at least one oxalate ester with at least one activator in the presence of at least one catalyst and at least one fluorescer.

It has been discovered that viscosity enhancing materials, such as, for example, waxes, silicas, gums, starches, food gels and/or polymers, when combined with chemiluminescent materials, produce a viscous, light emitting fluid that is highly useful for marking objects for the purposes of tagging, tracking, and locating. These compositions can readily adhere to a variety of substrates and are resistant to atmospheric exposure. Additionally, the viscous and thixotropic nature of these compositions permits them to be applied in thick layers without dripping or running. The consistency of the viscous compositions can be adjusted from that of a thin, syrupy liquid to a highly viscous dough-like material.

It is an object of the present disclosure to provide chemiluminescent materials, compositions, and systems that permit signage to be created which emits light (visible, ultra-violet and/or infrared). The present disclosure also provides a multiple-part system, and materials and compositions for such a multiple-part system, that upon activation emits light, and possess properties which are highly desirable for creating significantly improved light emitting indicia on a wide variety of surfaces. This can be achieved by employing a chemiluminescent system that can emit light upon activation, in combination with suitable viscosity enhancing materials. “Activation” as used herein means that a chemical reaction between the multiple components has started. More specifically, it has been discovered that certain viscosity modifying agents, such as waxes, silicas, gums, starches, food gels and/or polymers, when combined with chemiluminescent materials, produce a viscous, light emitting fluid suitable for this task.

One embodiment of the present disclosure is directed to a chemiluminescent composition which upon activation emits light (visible, ultra-violet and/or infrared), and which possesses properties that allow signage generated from the light-emitting material to be created on a wide variety of surfaces independent of surface orientation. This can be achieved by employing a chemiluminescent component that can emit light upon activation, in combination with a suitable viscosity enhancing material. In certain embodiments, the at least one activator for the chemiluminescent composition is combined with a suitable viscosity enhancing material. In other embodiments, the at least one oxalate ester for the chemiluminescent composition is combined with a suitable viscosity enhancing material. In certain embodiments, the at least one activator for the chemiluminescent composition and the at least one oxalate ester for the chemiluminescent composition are independently combined with suitable viscosity enhancing materials.

For all of these embodiments, it is desirable that the individual viscous components and/or the resulting chemiluminescent composition not be easily removed from marked surface. It is also desirable that the individual viscous components and/or the resulting chemiluminescent composition not be easily degraded by exposure to rain, snow or other ambient conditions. Another desirable feature of the individual viscous components and/or the resulting chemiluminescent composition is that the “gels” not undergo significant changes in their viscosity over the temperature range that the compositions will be used in. For example, a conventional marking device left in a hot vehicle might be exposed to temperatures exceeding 60 degrees Celsius which could cause melting and deformation or dissolution of the chemiluminescent components, such as the oxalate composition. The viscosity modifying agents of the present disclosure are chosen to remain functional over a wide temperature range. It is contemplated that the individual viscous components and/or the resulting chemiluminescent composition provided by the present disclosure possess at least one of the desirable attributes described above.

For example, one aspect of the present disclosure is directed to a chemiluminescent marking composition comprising at least one viscosity enhancing material, at least one first reactant, and at least one second reactant. In certain embodiments, the chemiluminescent composition comprises at least one first reactant and at least one second reactant, wherein the at least one first reactant is chosen from a viscous oxalate composition, and in other embodiments, the chemiluminescent composition comprises at least one first reactant and at least one second reactant, wherein the at least one second reactant is chosen from a viscous activator. In further embodiments, the chemiluminescent composition comprises at least one first reactant and at least one second reactant, wherein the at least one first reactant is chosen from a viscous oxalate composition and the at least one second reactant is chosen from a viscous activator.

The at least one first reactant and the at least one second reactant must be kept separated until use, at which time they are combined and light generation commences.

In another aspect of the present disclosure, at least one of the reactants may be contained inside a housing which keeps the at least one first reactant of the marking composition separate from the at least one second reactant of the marking composition, until such time as mixing is desired. Another aspect of the disclosure includes a plurality of flexible packages that serve to keep the at least one first reactant and the at least one second reactant separated.

In a further embodiment, the present disclosure is directed to a containment device comprising:

(a) at least one first containment part,

(b) at least one second containment part, and

(c) at least one barrier separating the at least one first containment part and the at least one second containment part, wherein the at least one barrier comprises at least one tear initiator and at least one activation mechanism comprising opposing grip portions that, when pulled apart, can provide sufficient tension to the at least one tear initiator to allow fluid communication between the at least one first containment part and the at least one second containment part. The components of the chemiluminescent marking composition disclosed in the present disclosure are contemplated to be contained in such housing and/or containment devices.

In a further embodiment, the present disclosure is directed to a containment device comprising:

(a) at least one first containment part,

(b) at least one second containment part,

(c) at least one barrier separating the at least one first containment part and the at least one second containment part, and

(d) at least one activation mechanism that, upon activation, allows fluid communication between the at least one first containment part and the at least one second containment part. In certain embodiments, the at least one activation mechanism comprises opposing grip portions that, when pulled apart, can provide sufficient tension to allow fluid communication between the at least one first containment part and at least one second containment part. The components of the chemiluminescent marking compositions disclosed in the present disclosure are contemplated to be contained in such housing and/or containment devices.

Other objects of the present disclosure are to provide both a viscous oxalate composition that can be combined with suitable activators to produce glowing, viscous compositions, as well as a viscous activator composition that can be combined with suitable oxalates to also produce glowing, viscous compositions. These resulting compositions can then be used for marking a variety of surfaces such as may be useful for tagging, tracking and locating. The viscous oxalate and/or viscous activator compositions can have several desirable attributes over less viscous solutions. For example, viscous oxalate and/or viscous activator compositions “stay put” when applied to a surface, particularly a vertical surface. Further, viscous oxalate and/or viscous activator compositions may be applied in and maintained at greater thickness on a substrate to be marked, resulting in more material per unit area and hence, greater light output per unit area. Additionally, viscous oxalate and/or viscous activator compositions can be more readily mixed with the other chemiluminescent components (as compared, for example, with attempting to mix a viscous activator component with a low viscosity oxalate.) Furthermore, viscous oxalate and/or viscous activator compositions can be “self protecting” from the damaging effects of water vapor in the air because the viscous composition helps prevent the transport of water vapor from the surface of the gelled mass to below the surface of the mass where it could damage the oxalate.

A further embodiment of the present disclosure is directed to a chemiluminescent, multiple-part marking system comprising at least one first reactant and at least one second reactant, wherein the at least one first reactant is chosen from a viscous oxalate composition and the at least one second reactant is chosen from a viscous activator. Another embodiment of the present disclosure is directed to a chemiluminescent, multiple-part marking system comprising at least one first reactant and at least one second reactant, wherein the at least one first reactant is chosen from a viscous oxalate composition, and yet another embodiment of the present disclosure is directed to a chemiluminescent, multiple-part marking system comprising at least one first reactant and at least one second reactant, wherein the at least one second reactant is chosen from a viscous activator. The reactants must be kept separated until use, at which time they are combined and light generation commences. One of the reactants may be contained inside a container which keeps the at least one first reactant of the marking system separate from the at least one second reactant of the marking system, until such time as mixing is desired.

Another embodiment of the present disclosure is directed to a viscous oxalate composition. In certain embodiments, the viscous oxalate composition can be a fluid with a viscosity ranging from 15 to 10,000,000 centipoise. The consistency of the viscous oxalate composition can range from near that of liquid water to extremely viscous pastes. In certain embodiments, the viscous oxalate composition is a solution, and in further embodiments, the viscous oxalate composition is a suspension. When the viscous oxalate composition is combined with a suitable activator chemiluminescent light is produced.

A further embodiment of the present disclosure is directed to a viscous activator composition. In certain embodiments, the viscous activator composition can be a fluid with a viscosity ranging from 15 to 10,000,000 centipoise. The consistency of the viscous activator composition can also range from near that of liquid water to extremely viscous pastes. In certain embodiments, the viscous activator composition is a solution, and in further embodiments, the viscous activator composition is a suspension. When the viscous activator composition is combined with a suitable oxalate chemiluminescent light is produced.

The present disclosure is also directed to a method of producing viscous or gelled chemiluminescent oxalate compositions, a method of producing viscous activator compositions, a method of producing viscous or gelled chemiluminescent compositions, as well as methods for storing, mixing and dispensing mixtures of these chemiluminescent components and compositions.

Other aspects of the present disclosure include a plurality of containers that serve to keep first and second reactants separated.

Additional objects and advantages of the disclosure will be set forth in part in the description which follows, and in part will be obvious from the description, or may be learned by practice of the disclosure. The objects and advantages of the present disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate one embodiment of the disclosure and together with the description, serve to explain the principles of the disclosure.

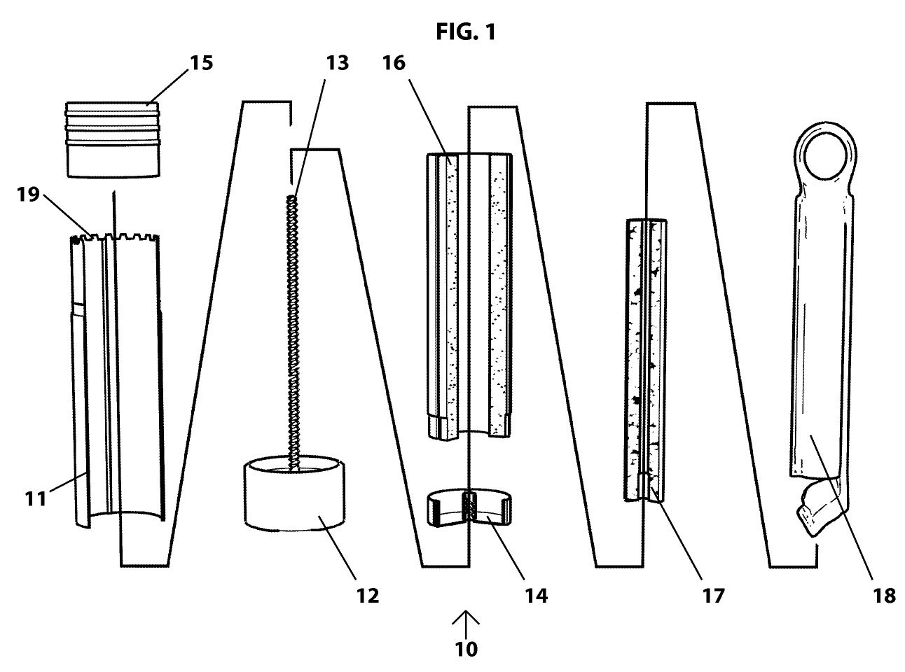

FIG. 1 represents a cut-away, exploded view of a marking system illustrating a first container comprising at least one first reactant. A second container comprising at least one second reactant is also depicted.

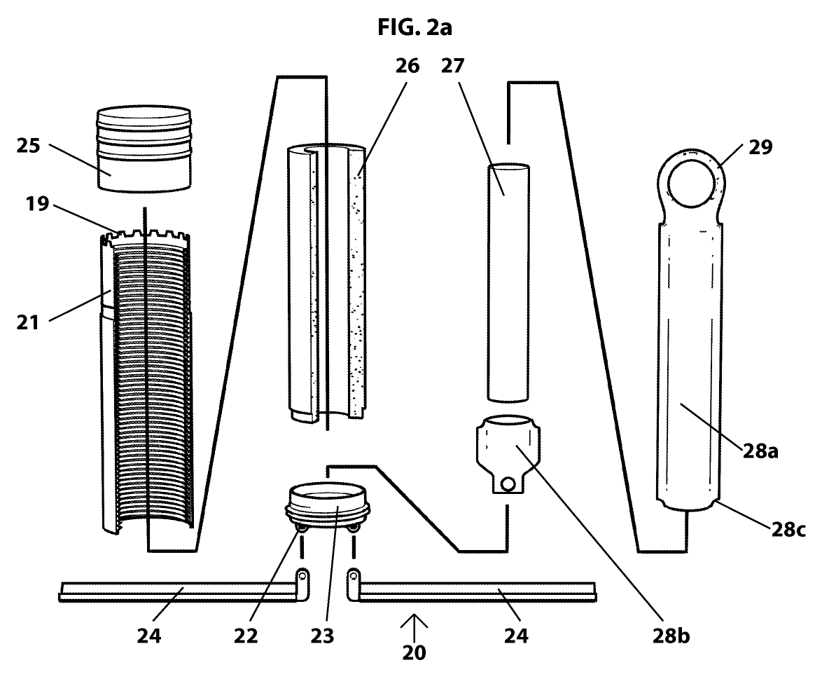

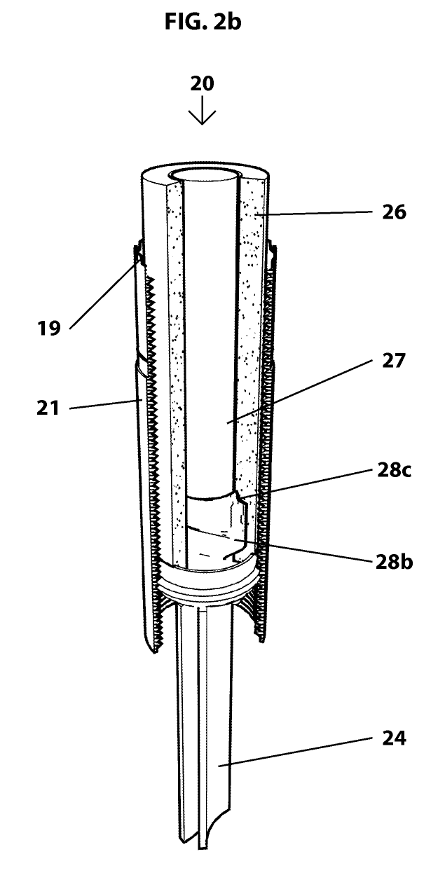

FIG. 2a represents the marking system illustrating a first container containing at least one first reactant. A second container contains at least one second reactant residing primarily within a void within the at least one first reactant.

FIG. 2b represents the marker depicted in FIG. 2a in application.

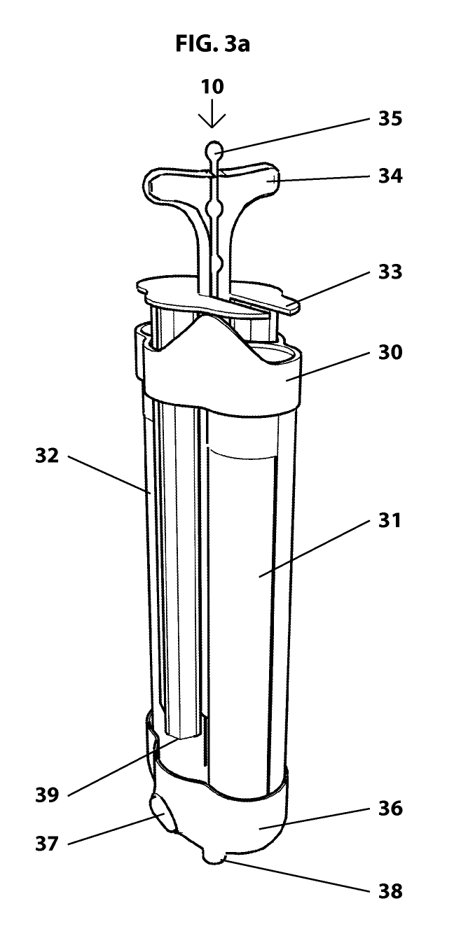

FIGS. 3a and 3b represent a dual-component storage, mixing and dispensing system containing chemiluminescent reactants.

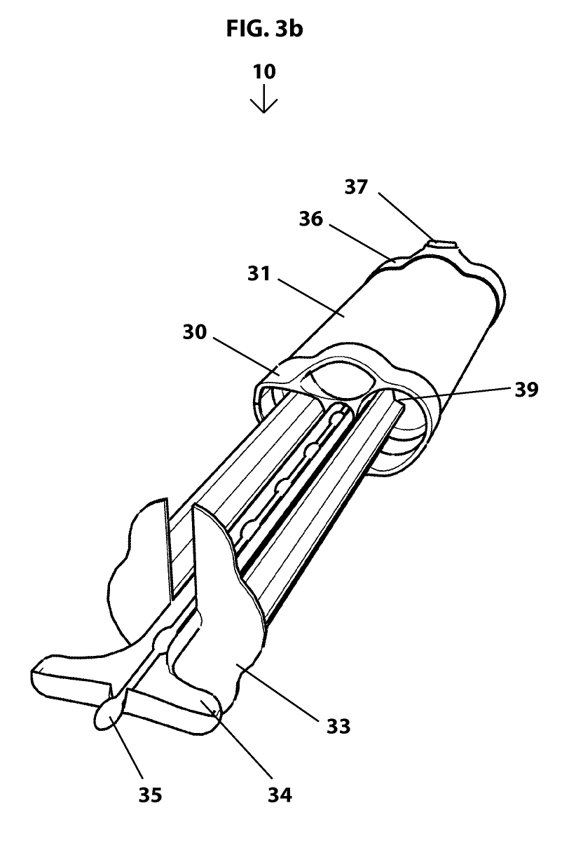

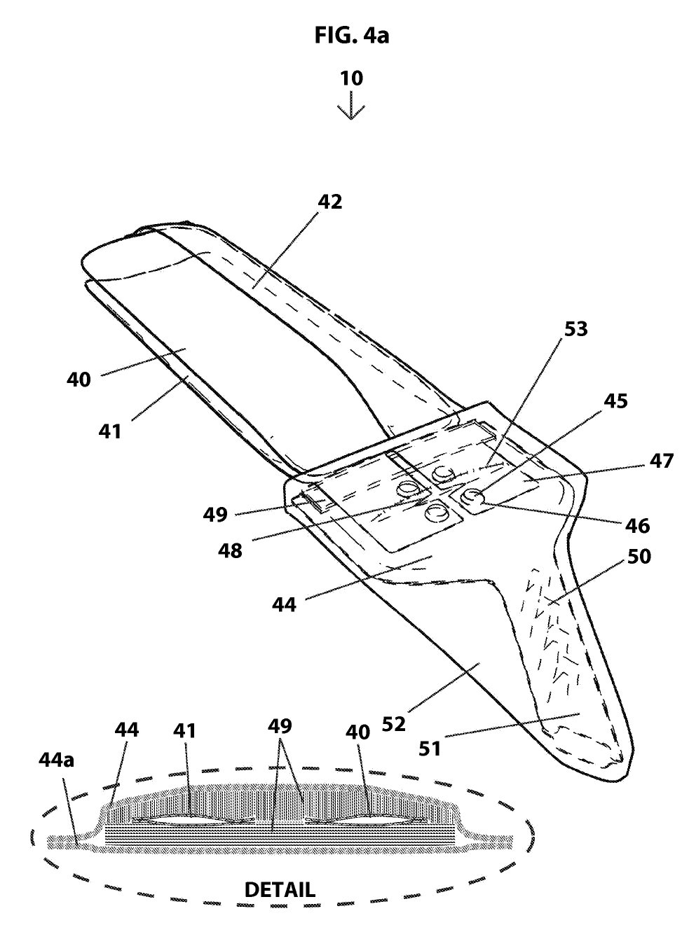

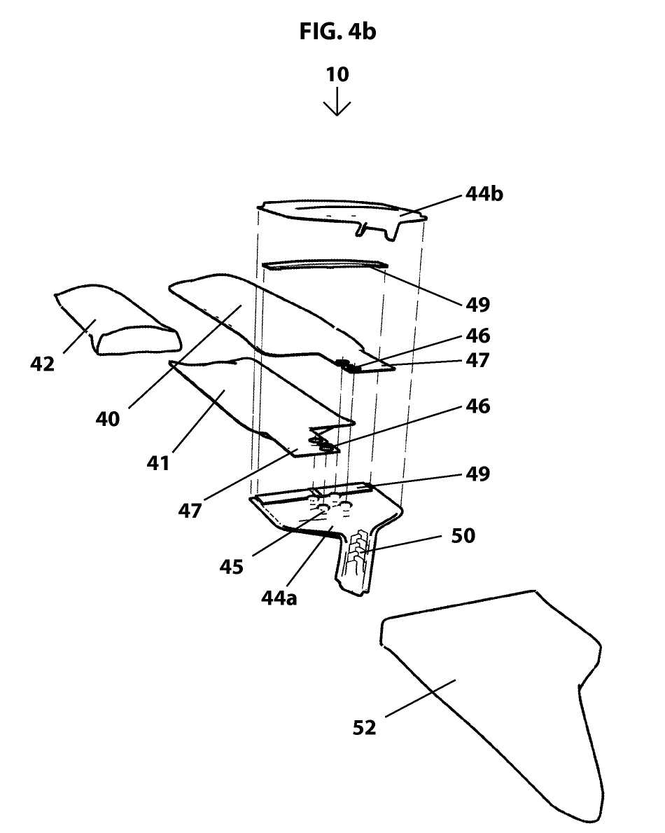

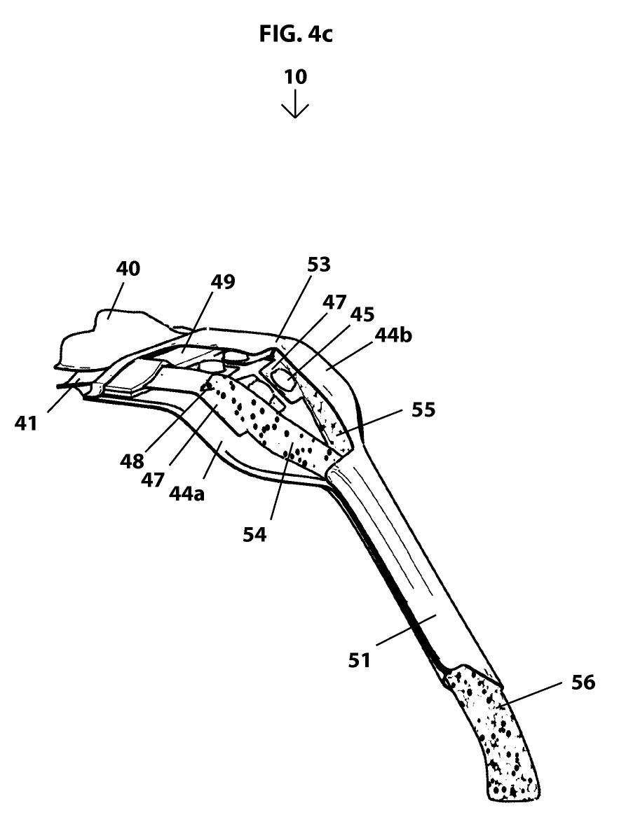

FIGS. 4a, 4b, and 4c represent a dual-component storage, mixing and dispensing system containing chemiluminescent reactants in which the storage means comprise at least one flexible container.

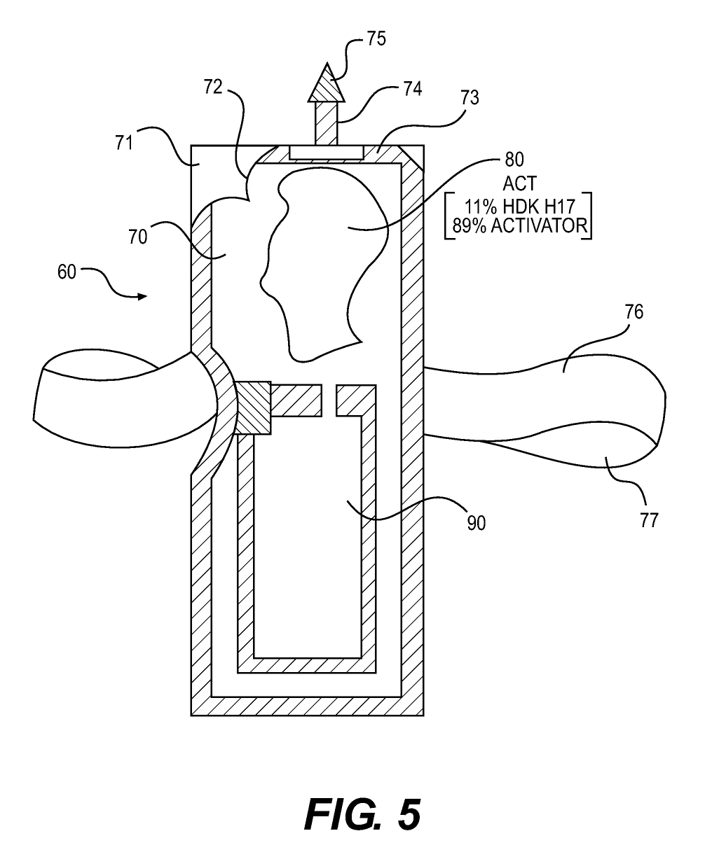

FIG. 5 represents a marking system according to the present disclosure wherein a first flexible container containing a first reactant is illustrated. The first flexible container also contains at least one, second flexible container which contents comprise a second reactant.

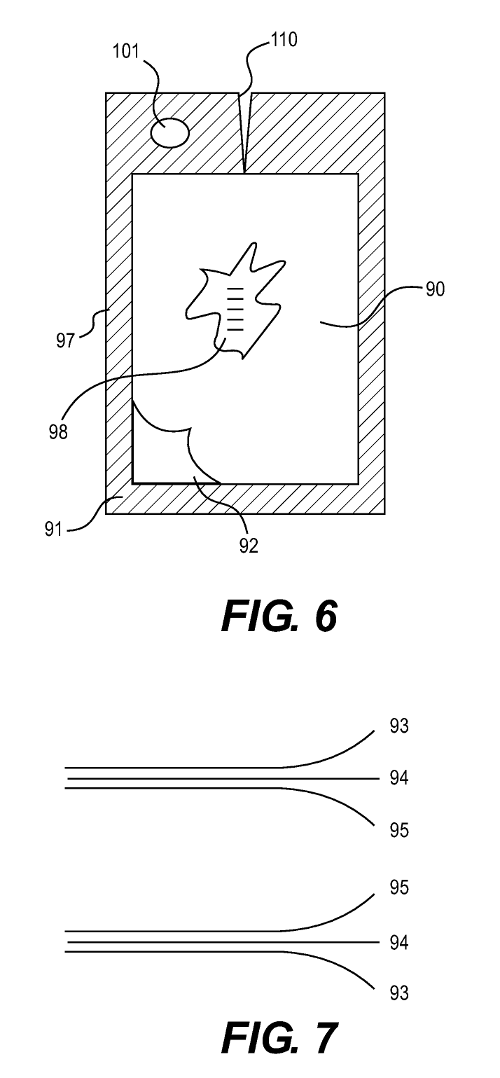

FIG. 6 represents a detailed view of the second flexible container.

FIG. 7 represents a cross section view of the structure of second flexible container.

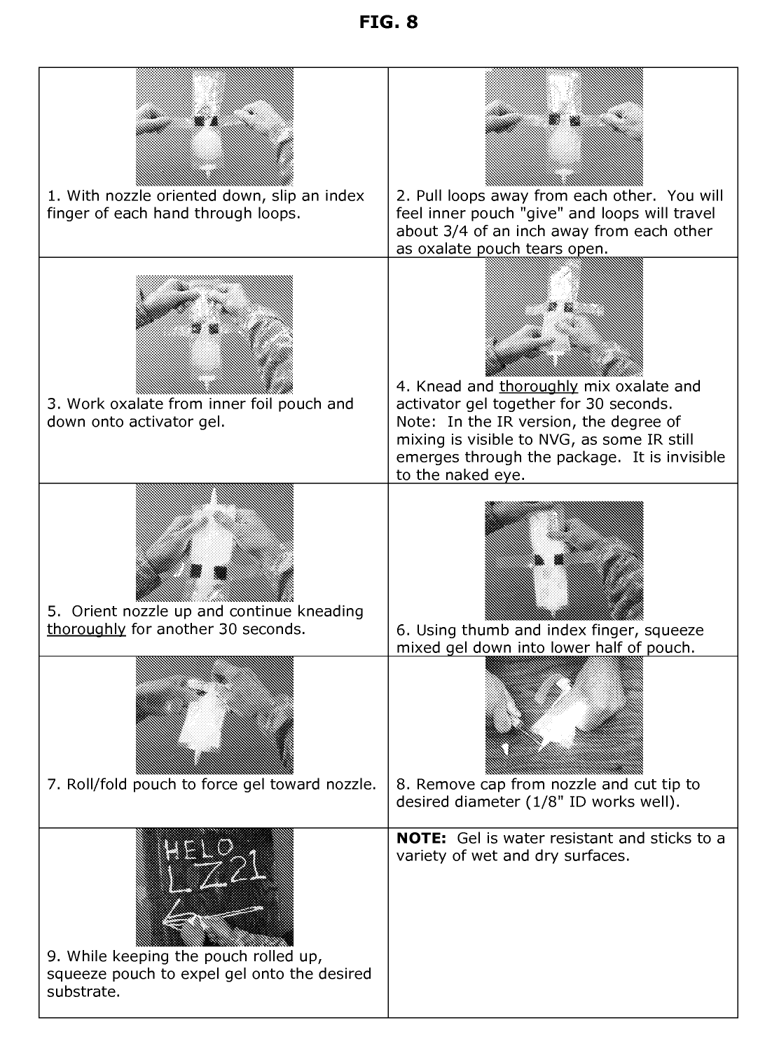

FIG. 8 represents instructions for use of one embodiment of the present disclosure.

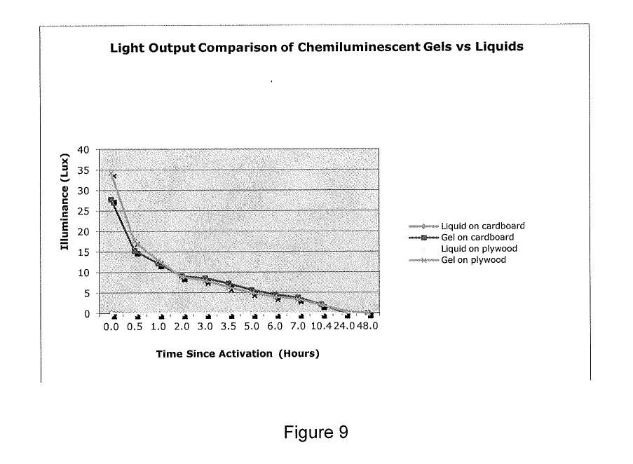

FIG. 9 illustrates the illuminance of each of four test samples.

Referring to FIG. 1, the embodiment 10 depicted therein comprises first container 11 which may be fabricated from a thermoplastic or other suitable material. A second container 18 is comprised of a metallic foil, glass, plastic or other suitable material. A rotatable base 12 is provided which is operably coupled to screw 13. A piston 14 is provided such that when base 12 is rotated relative to first container 11, the action of screw 13 causes piston 14 to move longitudinally within first container 11. Grooves and mating splines that are formed into the piston and the interior wall of first container prevent the piston from rotating relative to the first container. Residing within first container is at least one first reactant 16, for example, an activator. Residing in second container 18 is at least one second reactant 17, for example, a viscous oxalate composition. Prior to initial use, the oxalate is removed from second container and placed within the space provided within the at least one first reactant. While a co-axial relationship between the first and second reactants is shown, other arrangements are of course possible as well.

When rotatable base 12 is rotated relative to first container 11, movement of piston 14 urges both first reactant 16 as well as second reactant 17 away from the base and out of the container. First and second reactants are of a rheology that is capable of creating a smear or a trail of “pilings” when placed in contact with a surface and drawn across that surface, in an action similar to that of writing with a “grease pen” or “paint stick.” As the device is drawn across the surface to be marked upon, the first and second reactants simultaneously become deposited on the surface. In the process of deposition, the reactants are also admixed, thereby initiating the production of chemiluminescent light and hence, creating light emitting indicia. A mixing element 19 may be employed to further promote mixing of the two reactants, said mixing element comprising a plurality of bristles, fingers of the like. A cover 15 may be provided to protect the contents of the device when not in use.

Referring to FIGS. 2a and 2b, a first container 20 is provided with a piston 23 with pivot 22. Said piston 23 is situated within container 21. Threads or other suitable means are provided to permit the piston to move relative to first container 21 when a rotating action is applied relative to container 21 and piston 23. Handles 24 may be provided to aid in the generation of this relative motion. A cover 25 protects contents between use. First reactant 26 is situated inside of container 21. Second reactant 27 is situated inside of frangible container 28a that is, in turn, positioned inside of first reactant 26. A failure initiator 28c, such as a tear initiator notch, is provided to promote failure of frangible container 28a at a desired location. A lower portion 28b of frangible container 28a is located on the opposite end of failure initiator 28c. This second section is captivated by bonding or otherwise attaching to piston 23. A retainer element (not shown) is captivated similarly. A portion of this retainer element resides within the frangible container and extends into at least a portion of the second reactant, thereby constraining it and preventing second reactant from falling out of its position relative to first reactant. If frangible container 28a is of a foil laminate structure, said retainer element may be attached to that portion of the laminate seal that comprises the lower seal of frangible container 28a. To activate the device, cover 25 is first removed. Manual tensile force is applied to grip 29, in a manner so as to pull it away from first container 21. At a predetermined force, frangible container 28a fails at failure initiator 28c and the upper portion of frangible container 28a is separated from the lower portion 28b there by exposing second reactant 27.

Handles 24 are pulled away from first container 21 and folded down as illustrated in FIG. 2b. Twisting these handles relative to first container causes piston 23 to move upwards and simultaneously expel first and second reactants from the first container. The device may then be used to create indicia by drawing the exposed reactants over the surface to be written on. Handles may be retracted and folded for compact storage. In an alternate embodiment, the piston does not comprise threads. In this embodiment the threads or other engaging means with the first container side-wall are integral to the handles. In this form, folding the handles to their original position disengages them from the threads or other engaging means in the side-wall of the first container.

FIGS. 3a and 3b show a version of the device in which two pistons are used to expel viscous chemiluminescent fluid from a storage container. The device comprises a dual cylindered vessel 30 in which a first reactant 31 and a second reactant 32 are stored. Said first and second reactants are separately contained within the interior spaces of the cylinders. If desired, a secondary protective container such as a metallized foil container or a metal tube may be provided within one or both cylinders. The purpose of said secondary container is to further protect the reactant from exposure to the atmosphere. A piston assembly 33 comprises two pistons. Between use, these pistons may be conveniently stored outside of and adjacent to the cylinders to which they will operate as is illustrated in FIG. 3a.

The tip of one or both of the pistons may be equipped with a perforator 39, if desired. Said perforator being useful if the previously mentioned secondary container is to be employed that requires puncturing or perforation to permit expulsion of the contents. A second perforator may be employed near the nozzle end of the device so that a second end of the container may also be perforated. Follower pistons (not shown) may reside either within or outside of the containers or secondary containers to form slidable liquid tight seals. These follower pistons then slide along the length of the containers as they are urged by the pistons. Such a container may comprise a metallic foil bag, pouch, or tube or other container with a perforable or frangible element.

Handle 34 is used to manually pull the piston assembly from its storage position. The piston assembly is then rotated so as to align the pistons with the cylinders and the piston tips are inserted into the cylinder tubes. An elastic member 35 or other spring element may be employed to urge the piston assembly down the cylinders, thereby pressurizing the reactant gels, fluids or pastes. The member shown comprises a series of beads or other stop means which permit the force generated by the elastic member to be adjusted by simply tightening or loosening the member with respect to its position relative to pull handle 34. A static mixer 36 (not shown) may be incorporated into the path of the reactants between the respective outlets of the cylinders, or in the case of secondary containment means, the outlets of the secondary container and nozzle 38. The purpose of the static mixer is to promote admixing of the reactants prior to exiting the device. A valve actuator 37 may be provided to permit the flow control of the reactants. A nozzle 38 controls the shape of the fluid stream as the fluid exits the device.

FIGS. 4a, 4b, and 4c detail an embodiment of the device 10 incorporating flexible pouches to store, mix and dispense chemiluminescent materials. A first flexible container 40 comprises a structure with an interior space and an exterior space. The interior space can contain a first reactive component. A container of this type may be fabricated by sealing sheets of laminar material, such as metallic foil structures, around their periphery. This peripheral seal may be achieved by heat sealing, RF welding, ultrasonic welding or any other suitable means. A second flexible container 41 may be produced in a similar manner, and can be used to contain the second reactive component. A protective sleeve 42 may be provided to keep said first and second flexible containers co-located. This sleeve may also protect the flexible containers from physical damage, exposure to actinic light, etc.

Component 53 functions as a flexible and distensible member, similar to a “live hinge.” As the nose of the dispensing device is flexed downwards, component 53 permits a low force distension of the uppermost member of the dispensing assembly. The dispensing assembly comprises a first dispensing member 44a and a second dispensing member 44b that are sealingly joined together about a portion of their periphery. During flexing, dispensing member 44b, being under tensile force, distends; component 53 assists in this distension. Activation occurs when the tensile force which is also generated in distal potions of the reactant containing pouches 40 and 41 exceeds the yield strength of the pouches. At this point, the pouches fail (preferably at a tear initiator) and the fluid contents are released.

Registration pins 45 or other suitable means provide a method to locate and contain mating registration holes in flags 47. Flags being formed as a component of the flexible pouch structure, which flags may or may not have an interior hydraulic space. Tear initiators 48, which may be in the form of notches, serve as force concentrators and promote tearing of the flexible pouches proximal to the initiator when force is applied across the initiator. A hydraulic seal 49 is provided which serves to define the interior space of the dispensing assembly with respect to the exterior surfaces of the flexible containers. One means of creating this hydraulic seal is by adhesively bonding a portion of the flags extending from the flexible containers to the inside of the dispensing members. A pressure-sensitive, foam tape structure is particularly useful for this purpose.

A static mixer 50 may be incorporated into the dispensing assembly 43. Said mixer comprising interdigitated vanes, fingers or the like. A dispensing nozzle 51, which may or may not be integral to dispensing assembly 43 may be employed to control flow and extrudate diameter and shape. A removable cap 52 may be employed to protect the nozzle from damage, as well as to prevent stray extrudate from coming into contact with surfaces which are not to be marked.

Operation of the device is as follows. Protective cap 52 is removed from dispensing nozzle 51. A first portion of the dispensing assembly is flexed relative to a second portion of the dispensing nozzle. This flexing action creates a tensile force through a fulcrum action and hence, elongation of the flags which are pinned to the nozzle. Force created by this elongation causes the flags to fail at or near the tear initiators 48. Manual application of force to protective sleeve 42 is transferred to first and second flexible containers 40 and 41 creating a hydraulic pressure which expels contents 54 of first container 40 and contents 55 of second container 41 into the static mixer 50 and eventually out of the dispensing nozzle 51 as mixed contents 56. Flows 54, 55, and 56 will be maintained as long as force is applied to the containers and fluid remains in the containers. If it is desirable to terminate the flow, one need only stop application of force to the containers. A portion of the dispensing nozzle 51 may be folded back on itself to form a leak-tight seal if desired. Re-installation of cap 52 can be used to keep the nozzle folded upon itself if desired.

Referring to FIG. 5 depicting an embodiment of the present disclosure, a device 60 comprises first container 70 which may be fabricated from a first laminar element 71 and a second laminar element 72. A peripheral seal 73 is provided to join first and second laminar elements to create a sealed container of a defined volume. A fluid dispensing “fitment” 74 with an integral spout may be incorporated into said container. The fitment may or may not comprise a sealing cap 75.

Activation means 76 comprises a grippable region that may include finger loops 77. Residing within the interior space of container 70 is first reactant 80 comprising at least one peroxide, such as hydrogen peroxide. A second container 90 also resides within the interior space of first container 70. The first laminar element 71 and the second laminar element 72 are chosen from materials that are compatible with the chemiluminescent reactants. “Compatible” means the material is not significantly affected by the reactants and the reactants are not significantly affected by the material. Suitable compatible materials include, for example, polyethylene and polypropylene.

The thickness of the laminar elements 71 and 72 is selected to provide flexibility and robustness of the package. An opacifier may be incorporated into these laminar elements if it is desired to protect the container contents from light and/or prevent light generated by the chemiluminescent reaction from escaping the container. Peripheral seal 73 may be achieved by heat sealing, RF welding, ultrasonic welding or any other suitable means.

Fitment 74 should also be compatible with the reactants, and should afford easy and reliable sealing to laminar elements 71 and 72. A cap 75 may be provided to cover the tip of the fitment when the system is not in use. An example of a suitable fitment is produced by Innovative Packaging Network, Peach Tree City, Ga.

In another embodiment, container 70 may be produced without a fitment, in which case the container contents may be dispensed through a slit or other opening.

The activation means 76 may comprise an extension of first and second laminar elements that are joined at their distal ends to form a loop. A pair of these loops may be provided to permit activation of the device that will be discussed in detail later.

Referring to FIG. 6, second container 90 comprises a first laminate 91, and a second laminate 92. In this embodiment, both laminate 91 and 92 comprise the same structure. A tear initiator 110 is also depicted in FIG. 6.

Referring to FIG. 7, laminates 91 and 92 are comprised of laminar elements 93, 94 and 95. Laminar element 93 comprises an aluminum foil or other material with low water vapor transmission rate (WVTR). Laminar element 94 comprises a tie layer produced from a polypropylene suspension such as Morprime™ available from Rohm and Haas. Laminar element 95 comprises a polypropylene film. Laminar element 94 functions as a tie layer to permit reliable sealing of laminar elements 93 and 95. Sealing means may be accomplished by heat sealing, ultrasonic welding, or any other suitable process. Laminates 91 and 92 are arranged such that laminar elements 95 face one another.

Referring again to FIG. 6, a peripheral seal 97 is employed to create second container 90 with a defined interior volume. Prior to completion of peripheral seal 97, a quantity of second reactant 98 comprising at least one oxalate ester, at least one fluorescer and at least one solvent is positioned within second container 90. Bonding holes 101 are provided in peripheral seal 97 area to allow captivation of second container 90 by first container 70. Second container 90 is positioned within first container 70 such that the left most edge of second container 90 is immediately adjacent and parallel to inside of peripheral seal 73 at the left side of first container 70. Second container 90 is also arranged along the longitudinal axis of first container 70 such that the vertical center of bonding holes 101 aligns with the vertical center of activation means 76.

First laminar element 71 and a second laminar element 72 are bonded together through the left bonding hole 101, thereby fixing the location of first container 70 relative to the left hand side of second container 90. The inside of right hand longitudinal peripheral seal 73 of first container 70 is manipulated such that it is immediately adjacent to the right hand longitudinal edge of second container 90. First laminar element 71 and a second laminar element 72 are then bonded together through the right bonding hole 101, thereby fixing the location of first container 70 relative to the right hand side of second container 90.

This action causes the lateral dimension of laminar elements 71 and 72 to become foreshortened through warping or folding. In certain embodiments, excess air is removed from the first container 70 prior to sealing to make mixing easier.

The disclosure described above illustrates the use of flexible containers, but glass or other rigid material might also be employed.

The multiple-part marking systems of the present disclosure comprise a chemiluminescent marking composition comprising at least one viscosity enhancing material, at least one first reactant, and at least one second reactant. In certain embodiments, the at least one first reactant comprises at least one oxalate ester, and the at least one second reactant comprises at least one activator, such as hydrogen peroxide. It is contemplated that the components disclosed herein, for example, the suitable oxalate esters, viscosity modifying agents, fluorescers, catalysts, etc., can be used the various containment devices disclosed herein.

In certain embodiments of the present disclosure, suitable compositions for the at least one first reactant may be prepared by combining a liquid oxalate ester solution with at least one viscosity modifying agent chosen from a wax, ultra low density polyethylene, a petrolatum material, related paraffins, or any other any agent that does not degrade the reactants or otherwise interfere with the chemiluminescent reaction. Additional examples of suitable viscosity modifying agents could include polymeric thickening agents such as polyamides, polyvinyl chloride resins, polystyrenes, and polyacrylates, rubber modifiers, gums, starches, food gels, polyacrylamides, as well as fumed silica. In certain embodiments, combinations of any of these suitable viscosity modifying agents may also be usefully employed. rubber modifiers, gums, starches, food gels, polyacrylates, and polyacrylamides.

In certain embodiments, highly hydrophobic waxes can be employed, and these waxes can provide excellent resistance to water spray such as rain thus making removal of the applied chemiluminescent composition difficult. In other embodiments, paraffinic waxes (alkanes) can be employed, and these waxes produced an applied chemiluminescent composition that was not easily removed with solvents, rendering the marks more permanent.

More specific examples of suitable viscosity modifying agents that can be used include:
HP 7319 Wax, HP LDPE Polyethylene Wax, HP 5820 Fully Refined Paraffin Wax, and HP 5G, available from Hase Petroleum Wax Co., Arlington Heights, Ill.;
Vybar 343 Polymer, Be Square 165 Amber Wax, and Polywax 400 Polyethylene, available from Baker Hughes, Sugarland, Tex.;
Paraflex 4580A, available from The International Group, Titusville, Pa.; and
Petrolatum, available from various manufacturers.

It is possible to control the rheological properties and melt temperature of the viscous chemiluminescent materials as may be desired by controlling the ratios of the various viscosity modifying agents to one another as well as controlling the viscosity modifying agents ratios to the liquid oxalate. In general, W/W ratios of liquid oxalate to viscosity modifying agent were found to be functional over a range of approximately 5% oxalate to 95% viscosity modifying agent to approximately 60% oxalate to 40% viscosity modifying agent, with the mixtures containing more oxalate having a lower apparent viscosity. For example, suitable ratios of liquid oxalate to viscosity modifying agent include, for example, 10% oxalate to 90% viscosity modifying agent, 15% oxalate to 85% viscosity modifying agent, 20% oxalate to 80% viscosity modifying agent, 25% oxalate to 75% viscosity modifying agent, 30% oxalate to 70% viscosity modifying agent, 35% oxalate to 65% viscosity modifying agent, 40% oxalate to 60% viscosity modifying agent, 45% oxalate to 55% viscosity modifying agent, 50% oxalate to 50% viscosity modifying agent, and 55% oxalate to 45% viscosity modifying agent. In certain embodiments, the viscosity modifying agent is chosen from a wax or a mixture of various waxes.

Suitable oxalate esters can be chosen from bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2,4,5-trichloro-6-carboisopentoxyphenyl)oxalate; bis(2,4,5-trichloro-6-carbobenzoxyphenyl)oxalate; bis(2-nitrophenyl)oxalate; bis(2,4-dinitrophenyl)oxalate; bis(2,6-dichloro-4-nitrophenyl)oxalate; bis(2,4,6-trichlorophenyl)oxalate; bis(3-trifluoromethyl-4-nitrophenyl)oxalate; bis(2-methyl-4,6-dinitrophenyl)oxalate; bis(1,2-dimethyl-4,6-dinitrophenyl)oxalate; bis(2,4-dichlorophenyl)oxalate; bis(2,4-dinitrophenyl)oxalate; bis(2,5-dinitrophenyl)oxalate; bis(2-formyl-4-nitrophenyl)oxalate; bis(pentachlorophenyl)oxalate; bis(1,2-dihydro-2-oxo-1-pyridyl)glyoxal; bis(2,4-dinitro-6-methylphenyl)oxalate; bis-N-phthalimidyl oxalate, oxalates represented by the general formula (I)

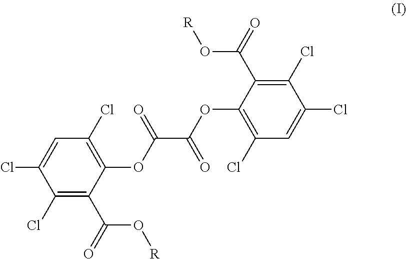

wherein R═CH₂A and A is chosen from alkyl chains, alkyl rings, and aromatic rings or combinations thereof, such that R is nonlinear and such that R comprises from 4-15 carbons, and mixtures of any of the foregoing oxalates.

Examples of oxalates represented by formula (I) include:
bis{3,4,6-trichloro-2-[(2-methylpropoxy)carbonyl]phenyl}oxalate;
bis{3,4,6-trichloro-2-[(cyclopropylmethoxy)carbonyl]phenyl}oxalate;
bis{3,4,6-trichloro-2-[(2-methylbutoxy)carbonyl]phenyl}oxalate;
bis{3,4,6-trichloro-2-[(3-methylbutoxy)carbonyl]phenyl}oxalate;
bis{3,4,6-trichloro-2-[(2,2-dimethylpropoxy)carbonyl]phenyl}oxalate;
bis{3,4,6-trichloro-2-[(2-methylpentyloxy)carbonyl]phenyl}oxalate;
bis{3,4,6-trichloro-2-[(3-methylpentyloxy)carbonyl]phenyl}oxalate;
bis{3,4,6-tri chloro-2-[(4-methylpentyloxy)carbonyl]phenyl}oxalate;
bis{3,4,6-trichloro-2-[(3,3-dimethylbutoxy)carbonyl]phenyl}oxalate;
bis{3,4,6-trichloro-2-[(2-ethylbutoxy)carbonyl]phenyl}oxalate;
bis{3,4,6-trichloro-2-[(cyclopentylmethoxy)carbonyl]phenyl}oxalate;
bis{3,4,6-trichloro-2-[(2-methylhexyloxy)carbonyl]phenyl}oxalate;
bis{3,4,6-trichloro-2-[(3-methylhexyloxy)carbonyl]phenyl}oxalate;
bis{3,4,6-trichloro-2-[(4-methylhexyloxy)carbonyl]phenyl}oxalate;
bis{3,4,6-trichloro-2-[(5-methylhexyloxy)carbonyl]phenyl}oxalate;
bis{3,4,6-trichloro-2-[(cyclohexylmethoxy)carbonyl]phenyl}oxalate;
bis{3,4,6-trichloro-2-[(phenylmethoxy)carbonyl]phenyl}oxalate;
bis{3,4,6-trichloro-2-[(2-phenylethoxy)carbonyl]phenyl}oxalate;
bis(3,4,6-trichloro-2-{[(2-methylphenyl)methoxy]carbonyl}phenyl)oxalate;
bis(3,4,6-trichloro-2-{[(3-methylphenyl)methoxy]carbonyl}phenyl)oxalate;
bis(3,4,6-trichloro-2-{[(4-methylphenyl)methoxy]carbonyl}phenyl)oxalate;
bis(3,4,6-trichloro-2-{[(2,3-dimethylphenyl)methoxy]carbonyl}phenyl)oxalate;
bis(3,4,6-trichloro-2-{[(2,4-dimethylphenyl)methoxy]carbonyl}phenyl)oxalate;
bis(3,4,6-trichloro-2-{[3,4-dimethylphenyl)methoxy]carbonyl}phenyl)oxalate;
bis(3,4,6-trichloro-2-{[(3,5-dimethylphenyl)methoxy]carbonyl}phenyl)oxalate;
bis(3,4,6-trichloro-2-{[(2,6-dimethylphenyl)methoxy]carbonyl}phenyl)oxalate;
bis(3,4,6-trichloro-2-{[(2-ethylphenyl)methoxy]carbonyl}phenyl)oxalate;
bis(3,4,6-trichloro-2-{[(3-ethylphenyl)methoxy]carbonyl}phenyl)oxalate;
bis(3,4,6-trichloro-2-{[(4-ethylphenyl)methoxy]carbonyl}phenyl)oxalate;
bis(3,4,6-trichloro-2-{[2-(2-methylphenyl)ethoxy]carbonyl}phenyl)oxalate;
bis(3,4,6-trichloro-2-{[2-(3-methylphenyl)ethoxy]carbonyl}phenyl)oxalate;
bis(3,4,6-trichloro-2-{[2-(4-methylphenyl)ethoxy]carbonyl}phenyl)oxalate;
bis{3,4,6-trichloro-2-[(2-phenylpropoxy)carbonyl]phenyl}oxalate;
bis{3,4,6-trichloro-2-[(3-phenylpropoxy)carbonyl]phenyl}oxalate;
bis{3,4,6-trichloro-2-[1-naphthalenylmethoxy)carbonyl]phenyl}oxalate;
bis{3,4,6-trichloro-2-[2-naphthalenylmethoxy)carbonyl]phenyl}oxalate;
bis{3,4,6-trichloro-2-[(2,2-diphenylethoxy)carbonyl]phenyl}oxalate;
bis{3,4,6-trichloro-2-[(9-fluorenylmethoxy)carbonyl]phenyl}oxalate; and
bis{3,4,6-trichloro-2-[(9-anthracenylmethoxy)carbonyl]phenyl}oxalate.

Additional examples of oxalates represented by general formula (I) are disclosed in U.S. Published Application No. 2011-0084243, the disclosure of such oxalates being incorporated herein by reference.

It is contemplated that suitable viscous oxalate compositions can be produced by combining at least one of the viscosity modifying agents disclosed herein with at least one of the oxalates disclosed herein. The viscous oxalate compositions can then be combined with a second reactant comprising at least one activator, which may be a viscous activator, in order to produce a chemiluminescent composition.

In addition to hydrogen peroxide as the activator, other suitable activators include sodium peroxide, sodium perborate, sodium pyrophosphate peroxide, urea peroxide, histidine peroxide, t-butyl hydroperoxide, peroxybenzoic acid, sodium percarbonate, and mixtures thereof.

As with the viscous oxalate, it is also possible to control the rheological properties and melt temperature of the viscous activator by controlling the ratios of the various viscosity modifying agents disclosed herein to one another as well as controlling the viscosity modifying agents ratios to the liquid activator. In general, W/W ratios of liquid activator to viscosity modifying agent were found to be functional over a range of approximately 5% activator to 95% viscosity modifying agent to approximately 60% activator to 40% viscosity modifying agent, with the mixtures containing more activator having a lower apparent viscosity. For example, suitable ratios of liquid activator to viscosity modifying agent include, for example, 10% activator to 90% viscosity modifying agent, 15% activator to 85% viscosity modifying agent, 20% activator to 80% viscosity modifying agent, 25% activator to 75% viscosity modifying agent, 30% activator to 70% viscosity modifying agent, 35% activator to 65% viscosity modifying agent, 40% activator to 60% viscosity modifying agent, 45% activator to 55% viscosity modifying agent, 50% activator to 50% viscosity modifying agent, and 55% activator to 45% viscosity modifying agent. It is contemplated that the activator can be combined with any of the viscosity modifying agents disclosed herein. In certain embodiments, the viscosity modifying agent is chosen from pyrogenic silica.

In certain embodiments, the ratio of the amount of viscous oxalate composition to activator can range from 1:6 to 6:1. For example, suitable weight ratios of the amount of viscous oxalate composition to activator range from 1:6, from 1:4, from 1:2, from 1:1, from 2:1, from 3:1, from 4:1, from 5:1, and from 6:1. In further embodiments, the ratio of the amount of oxalate to viscous activator composition can range from 1:6 to 6:1. For example, suitable weight ratios of the amount of oxalate to viscous activator composition range from 1:6, from 1:4, from 1:2, from 1:1, from 2:1, from 3:1, from 4:1, from 5:1, and from 6:1. In other embodiments, the ratio of the amount of viscous oxalate composition to viscous activator composition can range from 1:6 to 6:1. For example, suitable weight ratios of the amount of viscous oxalate composition to viscous activator composition range from 1:6, from 1:4, from 1:2, from 1:1, from 2:1, from 3:1, from 4:1, from 5:1, and from 6:1.

In certain embodiments, the amount of viscous oxalate composition can range of from 3 percent to 60 percent by weight, based on the total weight of the viscous chemiluminescent composition. For example, the at least one oxalate can be present in an amount ranging from 3 percent to 50 percent by weight, based on the total weight of the viscous chemiluminescent composition, such as from 3 percent to 40 percent by weight, from 3 percent to 30 percent by weight, from 5 percent to 25 percent by weight, and from 7 percent to 25 percent by weight. It is also intended that the amount of the at least one oxalate can range between any of the numerical values listed above.

In certain embodiments, the at least one activator is present in the liquid phase of the activator solution in an amount ranging from 0.25 percent to 25 percent by weight, based on the total weight of the viscous chemiluminescent composition disclosed herein. For example, the at least one activator can be present in an amount ranging from 0.25 percent to 20 percent by weight, based on the total weight of the chemiluminescent marking composition, such as from 0.5 percent to 20 percent by weight, from 0.5 percent to 15 percent by weight, from 0.5 percent to 10 percent by weight, and from 0.5 percent to 6 percent by weight. It is also intended that the amount of at least one activator can range between any of the numerical values listed above.

In certain embodiments, the resulting chemiluminescent composition comprising the viscous oxalate composition and/or the viscous activator has a viscosity ranging from 15 centipoise to 10,000,000 centipoise. For example, the resulting resulting chemiluminescent composition according to the present disclosure can be 25 centipoise or greater, 50 centipoise or greater, 100 centipoise or greater, 500 centipoise or greater, 1000 centipoise or greater, 2500 centipoise or greater, 5000 centipoise or greater, 7500 centipoise or greater, 10,000 centipoise or greater, 15,000 centipoise or greater, 50,000 centipoise or greater, 100,000 centipoise or greater, 250,000 centipoise or greater, 500,000 centipoise or greater, 1,000,000 centipoise or greater, 1,500,000 centipoise or greater, 2,000,000 centipoise or greater, 2,500,000 centipoise or greater, 3,000,000 centipoise or greater, 3,500,000 centipoise or greater, 4,000,000 centipoise or greater, 4,500,000 centipoise or greater, 5,000,000 centipoise or greater, 5,500,000 centipoise or greater, 6,000,000 centipoise or greater, 6,500,000 centipoise or greater, 7,000,000 centipoise or greater, 7,500,000 centipoise or greater, 8,000,000 centipoise or greater, 8,500,000 centipoise or greater, 9,000,000 centipoise or greater, or 9,500,000 centipoise or greater. In additional embodiments, the viscosity of the chemiluminescent marking composition according to the present disclosure can be 9,500,000 centipoise or less, 9,000,000 centipoise or less, 8,500,000 centipoise or less, 8,000,000 centipoise or less, 7,500,000 centipoise or less, 7,000,000 centipoise or less, 6,500,000 centipoise or less, 6,000,000 centipoise or less, 5,500,000 centipoise or less, 5,000,000 centipoise or less, 4,500,000 centipoise or less, 4,000,000 centipoise or less, 3,500,000 centipoise or less, 3,000,000 centipoise or less, 2,500,000 centipoise or less, 2,000,000 centipoise or less, 1,500,000 centipoise or less, 1,000,000 centipoise or less, 500,000 centipoise or less, 250,000 centipoise or less, 100,000 centipoise or less, 50,000 centipoise or less, 15,000 centipoise or less, 10,000 centipoise or less, 7,500 centipoise or less, 5,000 centipoise or less, 2,500 centipoise or less, 1,000 centipoise or less, 500 centipoise or less, or 250 centipoise or less. It is also intended that the viscosity of the chemiluminescent marking composition according to the present disclosure can range between any of the numerical values listed above. For example, in certain embodiments, the viscosity of the chemiluminescent marking composition according to the present disclosure can range from 100,000 centipoise to 1,500,000 centipoise.

In certain embodiments, the viscous chemiluminescent composition of the present disclosure can further comprise at least one fluorescer. Examples of the at least one fluorescer useful in the present disclosure include 1-methoxy-9,10-bis(phenylethynyl)anthracene; perylene; 16,17-didecycloxyviolanthrone; 2-ethyl-9,10-bis(phenylethynyl)anthracene; 2-chloro-9,10-bis(4-ethoxyphenyl)anthracene; 2-chloro-9,10-bis(4-methoxyphenyl)anthracene; 9,10-bis(phenylethynyl)anthracene; 1-chloro-9,10-bis(phenylethynyl)anthracene; 1,8-dichloro-9,10-bis(phenylethynyl)anthracene; 1,5-dichloro-9,10-bis(phenylethynyl)anthracene, 2,3-dichloro-9,10-bis(phenylethynyl)anthracene; 5,12-bis(phenylethynyl)tetracene; 9,10-diphenylanthracene; 1,6,7,12-tetraphenoxy-N,N′-bis(2,6-diisopropylphenyl)-3,4,9,10-perylene dicarboximide; 1,6,7,12-tetraphenoxy-N,N′-bis(2,5-di-t-butylphenyl)-3,4,9,10-perylene dicarboximide; 1,7-di-chloro-6,12-diphenoxy-N,N′-bis(2,6-diisopropylphenyl)-3,4,9,10-perylene dicarboximide; 1,6,7,12-tetra(p-bromophenoxy)-N,N′-bis(2,6-diisopropylphenyl)-3,4,9,10-perylene dicarboximide; 1,6,7,12-tetraphenoxy-N,N′-di-neopentyl-3,4,9,10-perylene dicarboximide; 1,6,7,12-tetra(p-t-butylphenoxy)N,N′-dineopentyl-3,4,9,10-perylene dicarboximide; 1,6,7,12-tetra(o-chlorophenoxy)-N,N′-bis(2,6-diisopropylphenyl)-3,4,9,10-perylene dicarboximide; 1,6,7,12-tetra(p-chlorophenoxy)-N,N′-bis(2,6-diisopropylphenyl)-3,4,9,10-perylene dicarboximide; 1,6,7,12-tetra(o-fluorophenoxy)-N,N′-bis(2,6-diisopropylphenyl)-3,4,9,10-perylene dicarboximide; 1,6,7,12-tetra(p-fluorophenoxy)-N,N′ bis(2,6-diisopropylphenyl)-3,4,9,10-perylene dicarboximide; 1,6,7,12-tetraphenoxy-N,N′-diethyl-3,4,9,10-perylene dicarboximide; 1,7-dibromo-6,12-diphenoxy-N,N′-bis(2-isopropylphenyl)-3,4,9,10-perylene dicarboximide; 16,17-dihexyloxyviolanthrone; rubrene; 1,4-dimethyl-9,10-bis(phenylethynyl)anthracene; and mixtures thereof.

In certain embodiments, the at least one fluorescer is present in an amount ranging from 0.05 percent to 0.9 percent by weight based on the total weight of the viscous chemiluminescent composition. For example, the at least one fluorescer can be present in an amount ranging from greater than 0.05 percent by weight to 0.9 percent by weight, based on the total weight of the viscous chemiluminescent composition, such as from 0.1 percent or greater by weight, from 0.2 percent or greater by weight, from 0.3 percent or greater by weight, from 0.4 percent or greater by weight, from 0.5 percent or greater by weight, from 0.6 percent or greater by weight, from 0.7 percent or greater by weight, and from 0.8 percent or greater by weight. In addition, the at least one fluorescer can be present in an amount ranging from 0.05 percent by weight to less than 0.9 percent by weight, based on the total weight of the viscous chemiluminescent composition, such as from 0.8 percent or less by weight, from 0.7 percent or less by weight, from 0.6 percent or less by weight, from 0.5 percent or less by weight, from 0.4 percent or less by weight, from 0.3 percent or less by weight, from 0.2 percent or less by weight, and from 0.1 percent or less by weight. It is also intended that amount of the at least one fluorescer can range between any of the numerical values listed above.

In additional embodiments, the viscous chemiluminescent composition of the present disclosure can further comprise at least one catalyst. Examples of the at least one catalyst useful in the present disclosure include sodium salicylate, lithium salicylate, 5-chlorolithium salicylate, triazoles, and imidazoles. For example, the at least one catalyst can be present in an amount ranging from greater than 0.0005 percent by weight to 10 percent by weight, based on the total weight of the viscous chemiluminescent composition, such as from 0.001 percent or greater by weight, from 0.005 percent or greater by weight, from 0.01 percent or greater by weight, from 0.05 percent or greater by weight, from 0.1 percent or greater by weight, from 0.25 percent or greater by weight, from 0.5 percent or greater by weight, from 1 percent or greater by weight, from 1.5 percent or greater by weight, from 2 percent or greater by weight, from 2.5 percent or greater by weight, from 3 percent or greater by weight, from 3.5 percent or greater by weight, from 4 percent or greater by weight, from 4.5 percent or greater by weight, from 5 percent or greater by weight, and from 7.5 percent or greater by weight. In addition, the at least one catalyst can be present in an amount ranging from 0.0005 percent by weight to less than 10 percent by weight, based on the total weight of the viscous chemiluminescent composition, such as from 7.5 percent or less by weight, from 5 percent or less by weight, from 4.5 percent or less by weight, from 4 percent or less by weight, from 3.5 percent or less by weight, from 3 percent or less by weight, from 2.5 percent or less by weight, from 2 percent or less by weight, from 1.5 percent or less by weight, from 1 percent or less by weight, from 0.5 percent or less by weight, from 0.25 percent or less by weight, from 0.1 percent or less by weight, from 0.05 percent or less by weight, from 0.01 percent or less by weight, from 0.005 percent or less by weight, and from 0.001 percent or less by weight. It is also intended that the amount of at least one catalyst can range between any of the numerical values listed above.

In certain embodiments, the viscous chemiluminescent composition according to the present disclosure can also comprise at least one carrier, i.e, solvent. Examples of the at least one carrier useful in the present disclosure include dimethyl phthalate, dibutyl phthalate, dioctal phthalate, butyl benzoate, acetyl triethyl citrate, triethyl citrate, ethylene glycol dibenzoate, glycerol tribenzoate, and propylene glycol dialkyl ether containing one to three propylene moieties and each alkyl group is independently a straight-chain or branched-chain alkyl group containing up to 8 carbon atoms. In certain embodiments, the carrier is chosen from dimethyl phthalate, triethyl citrate, ethylene glycol dibenzoate, glycerol tribenzoate, propylene glycol dialkyl ethers containing two propylene moieties such as dipropylene glycol dimethyl ether, dipropylene glycol diethyl ether and dipropylene glycol di-t-butyl ether, dibutyl phthalate, butyl benzoate, propylene glycol dibenzoate, ethyl-hexyl diphenyl phosphate, and mixtures thereof.

In certain embodiments, the at least one carrier is present in an amount ranging from 5 percent to 95 percent by weight, based on the total weight of the viscous chemiluminescent composition. For example, the at least one carrier can be present in an amount ranging from greater than 5 percent by weight to 95 percent by weight, based on the total weight of the viscous chemiluminescent composition, such as from greater than 10 percent by weight, from greater than 20 percent by weight, from greater than 30 percent by weight, from greater than 40 percent by weight, from greater than 50 percent by weight, from greater than 60 percent by weight, from greater than 70 percent by weight, from greater than 80 percent by weight, and from greater than 90 percent by weight. In addition, the at least one carrier can be present in an amount ranging from 5 percent by weight to less than 95 percent by weight, based on the total weight of the viscous chemiluminescent composition, such as from less than 90 percent by weight, from less than 80 percent by weight, from less than 70 percent by weight, from less than 60 percent by weight, from less than 50 percent by weight, from less than 40 percent by weight, from less than 30 percent by weight, from less than 20 percent by weight, and from less than 10 percent by weight. It is also intended that the amount of at least one carrier can range between any of the numerical values listed above.

### EXAMPLES

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

### Example 1

A viscous chemiluminescent activator was formulated to serve as the first reactant in a chemiluminescent composition. First a liquid chemiluminescent activator was prepared by combining 2.1% by weight hydrogen peroxide, 0.9% H₂O by weight, 0.0015% sodium salicylate by weight, and approximately 97% by weight triethyl citrate. Eleven (11) percent by weight of siliconized pyrogenic silica (HDK H17), procured from Wacker Chemical Corp., Adrian, Mich., was combined with eighty-nine (89) percent by weight of the liquid chemiluminescent activator and thoroughly mixed to produce a viscous chemiluminescent activator gel.

Seventy five (75) grams of the viscous chemiluminescent activator gel can be put into the first container 70 depicted in FIG. 5, in which the gel is represented by shape 80.

A liquid chemiluminescent oxalate was prepared to be used as the second reactant. This liquid chemiluminescent oxalate comprised 23.5% by weight bis(2,4,5-trichloro-6-carbopentoxyphenyl)oxalate, 0.5% by weight 1-methoxy-9,10-bis(phenylethynyl)anthracene, 60% by weight butyl benzoate, and 16% by weight glycerol tribenzoate.

Twenty five (25) grams of the liquid chemiluminescent oxalate can be poured into second container 90 depicted in FIG. 5 prior to completing peripheral seal 97. In other embodiments, the amount of the viscous chemiluminescent activator gel and the liquid oxalate can be varied so that the ratio of the amount of the viscous chemiluminescent activator gel and the liquid oxalate can range from 1:6 to 6:1.

A ¼″ diameter hole punch was use to create bonding holes 101 depicted in FIG. 5. These bonding hole were located outside the wetted area of the package within the peripheral seal. A tear initiator 110 in FIG. 5 was produced by cutting through the laminate structure of second container 90 in the region of the peripheral edge 97 between bonding holes 101. The tear initiator 110 does not protrude into the wetted portion of second container 90 and serves to concentrate tensile forces applied between bonding holes 101 such that the integrity of second container 90 is violated when sufficient tensile force is applied to bonding holes 101. Using the aforementioned assembly process, second container 90 was inserted into and bonded to first container 70. Seventy-five grams of chemiluminescent activator gel was injected using a syringe-like device, into first container 70. The syringe was manipulated to position the chemiluminescent activator gel bolus between the fitment and the tear initiator 110. First container 70 was compressed to expel excess air and then sealed.

The assembled marking system was tested in the following manner: with the fitment oriented down, the test individual inserted the index finger from his left hand into left loop 27 and inserted his right index finger into right loop 27. Manual force was applied to pull the loops apart thereby creating a tensile force on tear initiator 60, rupturing second container 40 and expelling the liquid chemiluminescent oxalate. Remaining oxalate was squeezed out of second container 40 and into the interior space of first container 20. Manual force was applied to mix the oxalate and activator gel for about one minute. The fitment cap was removed and the tip of the fitment was removed by cutting. The first container was squeezed to expel the now glowing chemiluminescent gel through the fitment opening and onto an unpainted plywood substrate which was located out-of-doors. The marking system was used to create a variety of marks and symbols on the substrate.

Because of the thixotropic nature and relatively high viscosity of the gel, it was easy to create marks and symbols as desired. The indicia created adhered quickly and reliably to the substrate and created a relatively thick deposit approximately 2 to 10 mm thick. All marks glowed brightly and were highly visible to the naked eye in subdued lighting for in excess of 24 hours. The plywood substrate was left out-of-doors in a vertical orientation. The marks and symbols exhibited no significant runs or smearing. It was observed that some of the liquid phase of the glowing gel was absorbed into the wood.

### Example 2

A test was initiated to quantify the performance of the chemiluminescent gel relative to traditional chemiluminescent marking means. A mass of 120 grams of activator gel was prepared following the formulation previously disclosed. To this was added 40 grams of liquid oxalate. The components were thoroughly mixed thereby yielding a glowing gel. This glowing gel was applied first to a damp horizontally oriented plywood substrate using a doctor blade and spacer bars to create a gel thickness of approximately 3.5 mm. This thickness approximates that which might be expected when using the device of Example 1 above. The gel was spread over a 10 cm by 10 cm square area. The spreading process was repeated and gel was applied in the same geometry and to a dry section of horizontally oriented corrugated cardboard. Simultaneously, a preparation of liquid oxalate and liquid activator was prepared by combining 75 grams of liquid activator and 25 grams of liquid oxalate to produce a glowing chemiluminescent liquid. The oxalate and the activator used to prepare both the chemiluminescent gel and chemiluminescent liquid were from the same chemical lots.

The glowing liquid was applied liberally with a brush to a second horizontally oriented plywood substrate over an area 10 cm by 10 cm square. Likewise, the glowing chemiluminescent liquid was applied to a second horizontally oriented section of corrugated cardboard. All four substrates were then adjusted to a near vertical orientation whereupon a portion of the glowing chemiluminescent liquid was observed to run off the plywood and cardboard. On the substrates to which the chemiluminescent gel had been applied, there was no evidence of running or smearing. The chemiluminescent gel appeared significantly brighter than the chemiluminescent liquid regardless of the substrate. A laboratory light meter was used to measure illuminance of each of the four test samples. For every illuminance measurement, the light meter sensor was positioned 10 cm away from the glowing substrate. The results can be seen in Table 1, and illustrated in FIG. 9.

TABLE 1

| Time since | Light levels (lux) | | | |
|---|---|---|---|---|
| activation | Liquid on | Gel on | Liquid on | Gel on |
| (hr:min) | cardboard | cardboard | plywood | plywood |
| 0 | 0.41 | 27.80 | 0.06 | 34.30 |
| 0:30 | 0.06 | 15.30 | 0.01 | 17.60 |
| 1:00 | 0.03 | 12.20 | 0.00 | 12.90 |
| 2:00 | 0.02 | 9.10 | 0.00 | 8.90 |
| 3:00 | 0.01 | 8.60 | 0.01 | 8.00 |
| 3:30 | 0.02 | 7.30 | 0.02 | 6.40 |
| 5:00 | 0.02 | 5.70 | 0.02 | 5.00 |
| 6:00 | 0.02 | 4.60 | 0.02 | 4.00 |
| 7:00 | 0.02 | 3.80 | 0.02 | 3.40 |
| 10:25 | 0.02 | 2.10 | 0.02 | 2.00 |
| 23:18 | 0.02 | 0.08 | 0.02 | 0.48 |
| 47:14 | 0.00 | 0.00 | 0.00 | 0.03 |
| 70:10 | not visible | not visible | not visible | Visible to |
| | to naked | to naked | to naked | naked eye |
| | eye | eye | eye | |

Note:
Light meter readings less than 0.03 lux are below the noise threshhold of the instrument,

### Example 3

A viscous chemiluminescent oxalate was prepared to be used as the first reactant in the chemiluminescent compositions according to the present disclosure. A liquid chemiluminescent oxalate composition comprising 23.5% by weight bis(2,4,5-trichloro-6-carbopentoxyphenyl)oxalate, 0.5% by weight 1-methoxy-9,10-bis(phenylethynyl)anthracene, 60% by weight butyl benzoate, and 16% by weight glycerol tribenzoate. This liquid oxalate is then combined with a wax, ultra-low-molecular weight polyethylene or other suitable additive to form a viscous chemiluminescent composition. It is important that the additive be compatible with the chemiluminescent chemistry and not degrade or otherwise alter the performance of the chemiluminescent reaction. It is also important that the oxalate not degrade the additive and cause it to lose its functionality.

| | | |
|---|---|---|
| Formula 1 | HP LDPE | 63% |
| | Oxalate | 37% |
| Formula 2 | HP7319 | 67% |
| | Oxalate | 33% |
| Formula 3 | HP7319 | 57% |
| | Oxalate | 43% |
| Formula 4 | HP LDPE | 43% |
| | HP7319 | 21% |
| | Oxalate | 36% |

Preparation of the above formulations involved first heating the wax to approximately 10 degrees Centigrade above the waxes melting point. If more than one wax was used, the mixture was heated to 10 degrees above the highest melting point. After the wax was melted, the liquid oxalate was added to the melted wax. The mixture was stirred rapidly while under a bath of argon gas. The argon gas was used to avoid entraining air bubbles into the mixture, as the oxalate can be degraded by water vapor present in the air. The mixtures were allowed to cool and solidify while still being bathed in argon. It is believed that the oxalate/wax mixtures which resulted are suspensions rather than solutions, but in either case, the products performed well for the intended application. The resulting waxy solids were tested for efficacy by smearing a portion of each solid onto a variety of substrates, thereby creating a mark. The marks were then “activated” by smearing an activator, such as the activator described below, over the top of the wax/oxalate marks. The marks produced chemiluminescent light immediately and glowed brightly for more than of 12 hours thereafter.

A viscous activator gel was formulated according to Example 1 to serve as the at least one second reactant of the chemiluminescent compositions disclosed in this example. The liquid chemiluminescent activator was initially prepared by combining 2.1% by weight hydrogen peroxide, 0.9% H20 by weight, 0.0015% sodium salicylate by weight, and approximately 97% by weight triethyl citrate. As in Example 1, eleven (11) percent by weight of siliconized pyrogenic silica (HDK H17), procured from Wacker Chemical Corp., Adrian, Mich., was combined with eighty-nine (89) percent by weight of the liquid chemiluminescent activator and thoroughly mixed to produce a viscous chemiluminescent activator gel.

A variety of dispensing means for the viscous chemiluminescent materials was devised and detailed in FIGS. 1-9 described above.

What is claimed is:

1. A chemiluminescent, multiple-part marking system comprising at least one first reactant and at least one second reactant,
wherein the at least one first reactant is chosen from a viscous oxalate composition, and
wherein the at least one second reactant is chosen from a liquid activator.

2. The chemiluminescent, multiple-part marking system according to claim 1, wherein the viscous oxalate composition comprises at least one oxalate chosen from bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2,4,5-trichloro-6-carboisopentoxyphenyl)oxalate; and bis(2,4,5-trichloro-6-carbobenzoxyphenyl)oxalate, and at least one viscosity modifying agent chosen from low density polyethylene wax.

3. The chemiluminescent, multiple-part marking system according to claim 2, wherein the viscous oxalate composition has a viscosity ranging from 100,000 centipoise to 1,500,000 centipoise.

4. The chemiluminescent, multiple-part marking system according to claim 2, wherein the ratio of the at least one oxalate to the at least one viscosity modifying agent ranges from 1:4 to 4:1.

5. The chemiluminescent, multiple-part marking system according to claim 1, wherein the at least one activator is chosen from hydrogen peroxide.

6. A chemiluminescent, multiple-part marking system comprising at least one first reactant and at least one second reactant,
wherein the at least one first reactant is chosen from a liquid oxalate composition, and
wherein the at least one second reactant is chosen from a viscous activator composition.

7. The chemiluminescent, multiple-part marking system according to claim 6, wherein the viscous activator composition comprises hydrogen peroxide and at least one viscosity modifying agent chosen from pyrogenic silica.

8. The chemiluminescent, multiple-part marking system according to claim 6, wherein the oxalate is chosen from bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2,4,5-trichloro-6-carboisopentoxyphenyl)oxalate; and bis(2,4,5-trichloro-6-carbobenzoxyphenyl)oxalate.

9. The chemiluminescent, multiple-part marking system according to claim 7, wherein the viscous activator composition has a viscosity ranging from 100,000 centipoise to 1,500,000 centipoise.

10. A containment device comprising:
(a) at least one first containment part comprising at least one first chemiluminescent reactant,
(b) at least one second containment part comprising at least one second chemiluminescent reactant,
(c) at least one barrier separating the at least one first containment part and the at least one second containment part, and
(d) at least one activation mechanism that, upon activation, allows fluid communication between the at least one first containment part and the at least one second containment part.

11. The containment device according to claim 10, wherein the at least one activation mechanism comprises opposing grip portions that, when pulled apart, provide sufficient tension to allow fluid communication between the at least one first containment part and at least one second containment part.

12. The containment device according to claim 10, wherein the first chemiluminescent reactant is chosen from a viscous oxalate composition, and the second chemiluminescent reactant is chosen from hydrogen peroxide.

13. The containment device according to claim 12, wherein the viscous oxalate composition comprises at least one wax chosen from a low density polyethylene wax.

14. The containment device according to claim 10, wherein the first chemiluminescent reactant is chosen from an oxalate composition, and the second chemiluminescent reactant is chosen from a viscous hydrogen peroxide composition.

15. The containment device according to claim 14, wherein the viscous hydrogen peroxide composition comprises at least one viscosity modifying agent chosen from pyrogenic silica.
